(19) United States
(12) Patent Application Publication
(10) Pub. No.: US 2007/0009050 A1
(43) Pub. Date: Jan. 11, 2007

(54) Method and apparatus for update step in video coding based on motion compensated temporal filtering

(75) Inventors: Xianglin Wang, Irving, TX (US); Marta Karczewicz, Irving, TX (US); Yiliang Bao, Coppell, TX (US); Justin Ridge, Sachse, TX (US)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/402,620

(22) Filed: Apr. 11, 2006

Related U.S. Application Data
(60) Provisional application No. 60/670,315, filed on Apr. 11, 2005.
(60) Provisional application No. 60/671,156, filed on Apr. 13, 2005.

(51) Int. Cl. H04B 1/66; H04N 11/02; H04N 11/04

(52) U.S. Cl. 375/240.29; 375/240.16; 375/240.24

(57) ABSTRACT

The present invention reduces the complexity in the update step without significantly affecting the coding performance. In the update operation in motion compensated temporal filtering for video coding, an interpolation filter is adaptively selected from a short filter and a long filter so that the update signal can be obtained through the interpolation of prediction residue based on the interpolation filter. A short filter refers to a filter with a relatively small number of filter taps such as two. A long filter refers to a filter with a more than two filter taps.

The present invention is based on and claims priority to U.S. Provisional Patent Application No. 60/670,315, filed Apr. 11, 2005, and U.S. Provisional Patent Application No. 60/671,156, filed Apr. 13, 2005.

### FIELD OF THE INVENTION

The present invention relates generally to the field of video coding and, more specifically, to video coding based on motion compensated temporal filtering.

### BACKGROUND OF THE INVENTION

For storing and broadcasting purposes, digital video is compressed so that the resulting, compressed video can be stored in a smaller space than the original, uncompressed video content.

Digital video sequences, like ordinary motion pictures recorded on film, comprise a sequence of still images, the illusion of motion being created by displaying the images one after the other at a relatively fast frame rate, typically 15 to 30 frames per second. A common way of compressing digital video is to exploit redundancy between these sequential images (i.e. temporal redundancy). In a typical video at a given moment, there exists slow or no camera movement combined with some moving objects. Since consecutive images have similar content, it is advantageous to transmit only the difference between consecutive images. The difference frame, called prediction error frame Eₙ, is the difference between the current frame Iₙ and the reference frame Pₙ. The prediction error frame is thus given by
Eₙ(x,y)=Iₙ(x,y)−Pₙ(x,y),
where n is the frame number and (x, y) represents pixel coordinates. The predication error frame is also called the prediction residue frame. In a typical video codec, the difference frame is compressed before transmission. Compression is achieved by means of Discrete Cosine Transform (DCT) and Huffman coding, or similar methods.

Since video to be compressed contains motion, subtracting two consecutive images does not always result in the smallest difference. For example, when the camera is panning, the whole scene is changing. To compensate the motion, a displacement (Δx(x, y), Δy(x, y)) called motion vector is added to the coordinates of the previous frame. Thus prediction error becomes
Eₙ(x,y)=Iₙ(x,y)−Pₙ(x+Δx(x, y), y+Δy(x, y)).

In practice, the frame in the video codec is divided into blocks and only one motion vector for each block is transmitted, so that the same motion vector is used for all the pixels within one block. The process of finding the best motion vector for each block in a frame is called motion estimation. Once the motion vectors are available, the process of calculating Pₙ(x+Δx(x, y), y+Δy(x, y) is called motion compensation. Pₙ(x+Δx(x, y), y+Δy(x, y) is called motion compensated prediction.

In the coding mechanism described above, the reference frame Pₙ can be one of the previously coded frames. In this case, Pₙ is known at both the encoder and decoder. Such coding architecture is referred to as closed-loop.

Pₙ can also be one of original frames. In this case, the coding architecture is referred to as open-loop. Since the original frame is only available at the encoder but not the decoder, the decoder still has to use one of previously coded frames as reference frame. This may result in drift in the prediction process. Drift refers to the mismatch (or difference) of prediction Pₙ(x+Δx(x, y), y+Δy(x, y) between the encoder and the decoder due to different frames used as reference. Nevertheless, the open-loop structure becomes more and more often used in video coding, especially in scalable video coding due to the fact that open-loop structure makes it possible to obtain a temporally scalable representation of video by using lifting-steps to implement motion compensated temporal filtering (MCTF).

FIGS. 1a and 1b show the basic structure of MCTF using lifting-steps. In FIG. 1a, Iₙ and Iₙ₊₁ are original neighboring frames.

The lifting process consists of two steps: a prediction step and an update step. They are denoted by P and U respectively as shown in FIGS. 1a and 1b. FIG. 1a is the decomposition (analysis) process and FIG. 1b is the composition (synthesis) process. The output signals in the decomposition and the input signals in the composition process are H and L signals. H and L signals are derived as follows:
H=Iₙ₊₁−P(Iₙ)
L=Iₙ+U(H)
In fact, the prediction step P can be considered as motion compensation. The output of P, i.e. P(Iₙ), is the motion compensated prediction. Therefore, in FIG. 1a, H is the temporal prediction residue of frame Iₙ₊₁ based on the prediction of frame Iₙ. Thus, H signal generally contains temporal high frequency component of the original video signal. In the update step U, the temporal high frequency component in H is fed back to frame Iₙ in order to produce a temporal low frequency component L. For that reason, H and L are called temporal high band signal and low band signal, respectively.

In the composition process shown in FIG. 1b, the reconstruction frames I′ₙ and I′ₙ₊₁ are derived through the following operation:
I′ₙ=L−U(H)
I′ₙ₊₁=H+P(I′ₙ)
If signals L and H remain unchanged between the decomposition and composition processes as shown in FIGS. 1a and 1b, then obviously I′ₙ, and I′ₙ₊₁ would be exactly the same as Iₙ and Iₙ₊₁ respectively. In that case, perfect reconstruction can be achieved with such lifting steps.

The structure shown in FIGS. 1a and 1b can also be cascaded so that a video sequence can be decomposed into multiple temporal levels, as shown in FIG. 2 where two level lifting steps are performed. The temporal low band signal at each decomposition level can provide temporal scalability.

In the examples as shown in FIGS. 1a, 1b and 2, prediction and update only come from one direction. However, prediction and update can also come from two directions. For example, when bi-directional predicted frame (or B-frame) is used in video coding together with MCTF, two high band signals may be used in updating a current frame to get a low band signal. In this case, update comes from both directions.

In MCTF, the prediction step is essentially a general motion compensation process, except that it is based on an open-loop structure. In this process, a compensated prediction for the current frame is produced based on best-estimated motion vectors for each macroblock. Because motion vectors usually have sub-pixel precision, sub-pixel interpolation is needed in motion compensation.

In both AVC standard and the current SVC reference software (HHI JSVM software version 1.0 provided for JVT meeting, January 2005, Hong Kong, China), motion vectors have a precision of ¼ pixel. In this case, possible positions for pixel interpolation are shown in FIG. 3. In FIG. 3, A, E, U and Y indicate original integer pixel positions, and c, k, m, o, and w indicate half pixel positions. All other positions are quarter pixel positions.

In AVC standard, values at half pixel positions are obtained by using a 6-tap filter with impulse response (1/32, −5/32, 20/32, 20/32, −5/32, 1/32). The filter is operated on integer pixel values, along both horizontal direction and vertical direction as appropriate. For decoder simplification, 6-tap filter is not used to interpolate quarter pixel values. Instead, the quarter positions are obtained by averaging an integer position and its adjacent half pixel positions, and by averaging two adjacent half pixel positions as follows:
b=(A+c)/2,d=(c+E)/2,f=(A+k)/2,g=(c+k)/2,h=(c+m)/2,i=(c+o)/2,j=(E+o)/2 l=(k+m)/2,n=(m+o)/2,p=(U+k)/2,q=(k+w)/2,r=(m+w)/2,s=(w+o)/2, t=(Y+o)/2 v=(w+U)/2,x=(Y+w)/2
For the convenience of description, such interpolation method will be hereafter referred to as AVC standard interpolation.

An example of motion prediction is shown in FIG. 4. In FIG. 4, Aₙ represents a block in frame Iₙ and Aₙ₊₁ represents the block with the same position in frame Iₙ₊₁. Assume Aₙ is used to predict a block Bₙ₊₁ in frame Iₙ₊₁ and the motion vector used for prediction is (Δx, Δy) as indicated in the figure. Depending on motion vector (Δx, Δy), Aₙ can be located at a pixel or a sub-pixel as shown in FIG. 3. If Aₙ is located at a sub-pixel position, then interpolation of values in Aₙ is needed before it can be used as a prediction to be subtracted from block Bₙ₊₁.

In the update step, the prediction residue of the predicted block Bₙ₊₁ is added to the reference block along the reverse direction of the motion vectors used in the prediction step. According to FIG. 4, the motion vector that is used in the update step for block Aₙ should be (−Δx, −Δy). In this sense, the update step also includes a motion compensation process. Thus, the prediction residue frame obtained from the prediction step can be considered as being used as a reference frame. The reverse directions of those motion vectors in the prediction step are used as motion vectors in the update step. With such reference frame and motion vectors, a compensated frame can be constructed. The compensated frame is then added to frame Iₙ in order to remove some of the temporal high frequencies in frame Iₙ.

In fact the update process is performed only for integer pixels in frame Iₙ. If Aₙ is located at sub-pixel position, its nearest integer position block A′ₙ is actually updated according to motion vector (−Δx, −Δy). There is a partial pixel difference between pixel locations of blocks Aₙ and A′ₙ. In this case, because of the motion vector (−Δx, −Δy), the reference block for A′ₙ in the update step, denoted as B′ₙ₊₁ is not located at an integer pixel position either. There will be the same partial pixel difference between block Bₙ₊₁ and block B′ₙ₊₁. For that reason, interpolation is needed for obtaining prediction residue for block B′ₙ₊₁. Generally interpolation is always needed in the update step whenever motion vector (−Δx, −Δy) does not have an integer pixel displacement for both horizontal and vertical directions. In the current SVC reference model, the AVC standard interpolation method is used for sub-pixel interpolation in both prediction step and update step.

Instead of dealing with a block A′ₙ that can be located anywhere in the frame to be updated, in current SVC reference software the update step is performed block by block with a block size of 4×4 in this frame. Such rectangular block used as a coding unit is hereafter referred to as coding block for the ease of description. In current SVC reference software, all the motion vectors used in the prediction step are scanned to derive the best motion vectors for updating a coding block. Such motion vector is called update motion vector in the following description. By doing so, the regular block based motion compensation process used in prediction step can be directly applied to the update step, which simplifies the implementation of the update process.

In the prediction step, block Bₙ₊₁ is predicted from block Aₙ, as shown in FIG. 5. When block Aₙ is not aligned with the boundaries of the coding blocks, prediction may affect up to 4 coding blocks, as shown in FIG. 6. In FIG. 6, the four rectangular areas with solid borders indicate four coding blocks and the rectangular area with dashed border indicates the location of block Aₙ. As shown, Aₙ has an overlapped area with each of the four coding blocks, indicated by numerals 1, 2, 3 and 4. In this case, the update motion vector of Aₙ, i.e. (−Δx, −Δy) as shown in FIG. 5, is assigned to each of the four coding blocks. The size of (or number of pixels in) the overlapped area can be used as an indication as to how reliable the derived update motion vector is for the corresponding coding block. The bigger the overlapped area, the more reliable the motion vector is. Based on the number of overlapping pixels, the weight factor w₁ is calculated for each vector and each coding block and subsequently normalized to be in the range of [0,1]. When more than one update motion vector from the same reference frame is available for a coding block, the one with the largest weight factor w₁ is selected as the final motion vector for that coding block.

It should be noted that when bi-directional predicted frames (or B-frames) are used in video coding, it is common for a coding block in the updated frame to have two update motion vectors. The two vectors should come from different update directions. An example is shown in FIG. 7. In FIG. 7, the arrows indicate motion vectors in the prediction step. In the update step, the coding block around Aₙ would have two motion vectors to perform an update, one from each direction. In this case, the compensated prediction residue from each update direction is averaged and the result is used for update.

It is found that the update process in MCTF is helpful in improving coding performance in terms of objective quality of the coded video. However, it may also bring unwanted coding artifacts, which may be undesirable to the subjective quality of coded video. In order to avoid the unwanted coding artifacts, adaptive trade-off mechanisms have been created and used. One method is to measure the energy level of the prediction residue block that is to be used for update operation. If the energy is too high, it is more likely that the update operation could produce the unwanted visual artifacts. In this case the update strength needs to be lowered. For that reason, another weight factor, w₂, can be derived based on the energy of the prediction residue block used for update operation and can be used to control update strength. In cases where the energy is higher than predetermined threshold, the update step is not performed.

Weight factors w₁ and w₂ can be used jointly to determine the final update strength for a coding block. Assume Eₙ₊₁ is the prediction residue block used for the update operation, then instead of using Eₙ₊₁ directly, W₁*w₂*Eₙ₊₁ should be used for update in order to avoid possible coding artifacts. It should be noted that weight factor based on other criteria, e.g. quantization parameter qp which is a factor indicating how fine the quantization step is, may also be used to control the update strength. Generally, weight factor is an indicator showing how reliable or safe it is for the current update operation.

Although the MCTF technique is found to be useful in improving coding performance, complexity has always been a major concern. In a large part, the complexity is related to the update step because the prediction step is needed even without using MCTF. Therefore, for this technique to be widely adopted and used, reducing the update step complexity is desired and important.

In the current SVC reference model (JSVM software version 1.0 provided for JVT meeting, January, 2005, Hong Kong, China), the update step interpolation is the same as that for the prediction step, i.e. AVC standard interpolation. To derive update motion vectors, all motion vectors including motion vectors for 4×4 block are considered. As a result, an update motion vector has to be found for each 4×4 coding block. In estimating energy of a block that is to be used for update operation, the block is first interpolated using AVC standard interpolation if the block is not located at integer pixel positions and the energy of the block is calculated based on the interpolated pixels.

It is advantageous and desirable to simplify both the update step interpolation process and the update motion derivation process. It is also advantageous and desirable to simplify the energy estimation process, so that the weight factor calculation becomes less complex.

### SUMMARY OF THE INVENTION

The present invention aims to provide a method and device to reduce the complexity in the update step without significantly affecting the coding performance. In particular, the present invention provides simple but efficient methods for performing the update step in motion compensated temporal filtering for video coding.

The first aspect of the present invention provides a method for use in motion compensated temporal filtering of video frames, wherein the filtering of video frames comprises an update operation in which prediction residue is interpolated and fed back to low pass frame and wherein the interpolation of the prediction residue block is at least based on a filter for filtering interpolation. The filter is adaptively selected from a set of filters comprising at least a short filter and a long filter. A short filter refers to a filter with a relatively small number of filter taps such as two, and a long filter refers to a filter having more filter taps than the number of taps in the short filter. For example, a long filter may have four or more filter taps.

Thus, the method comprises:

adaptively selecting an interpolation filter from a set of filters comprising at least a shorter filter and a longer filter; and

obtaining update signal through interpolation of prediction residue based on said interpolation filter.

Advantageously, the interpolation filter is selected on a block basis from the set of filters based at least on a weight factor calculated for a block in a video frame comprising multiple blocks, and the method further comprises:

estimating an energy level of a prediction residue block corresponding to the block, wherein the estimating can be based on prediction residues at nearest integer pixel locations relative to the prediction residue block position in case the prediction residue block is located at partial pixel location, and
determining the weight factor for the block based at least on the estimated energy.

The interpolation filter can also be based on the number of update motion vectors available for a block in a video frame comprising multiple blocks, such that

if the number is one, comparing the weight factor of the block to a first predetermined threshold, such that if the weight factor is larger than the first predetermined value, select the longer filter as the interpolation filter, otherwise select the shorter filter as the interpolation filter; and

if the number is greater than one, comparing the weight factor of the block to a second predetermined threshold, such that if the weight factor is larger than the second predetermined value, select the longer filter as the interpolation filter, otherwise select the shorter filter as the interpolation filter.

The method further comprises deriving, for each block in a video frame, update motion vectors based on motion vectors used for blocks of at least a certain size or larger in prediction process of motion compensated temporal filtering of video frames.

The method further comprises:

comparing the weight factor of the block to a predetermined threshold;

selecting the longer filter as the interpolation filter if the weight factor is larger than the predetermined threshold; and

selecting the short filter as the interpolation filter if the weight factor is smaller than or equal to the predetermined threshold.

The second aspect of the present invention provides an electronic module which can be used in an encoder or a decoder, the electronic module has all the necessary blocks to carry out the update operation of motion compensated temporal filtering of video frames, according to the method of the present invention.

The third aspect of the present invention provides an encoder for use in motion compensated temporal filtering of video frames, the encoder has a module for carrying out the update method of the present invention.

The fourth aspect of the present invention provides a decoder for use in motion compensated temporal filtering of video frames, the decoder has a module for carrying out the update method of the present invention.

The fifth aspect of the present invention provides an electronic device, such as a mobile terminal. The electronic device comprises one or both of the encoder and decoder having a module for carrying out the update method of the present invention.

The sixth aspect of the present invention provides a software application product having a storage medium for storing program codes for carrying the update method of the present invention.

The present invention will become apparent upon reading the description taken in conjunction with FIGS. 8 to 16.

### BRIEF DESCRIPTION OF THE DRAWINGS

FIG. 1 shows both the decomposition and the composition process for MCTF using lifting structure.

FIG. 2 shows a two level decomposition process for MCTF using lifting structure.

FIG. 3 shows the possible interpolated pixel positions down to quarter pixels.

FIG. 4 gives an example of motion prediction as well as the associated blocks and motion vectors.

FIG. 5 shows update motion vector derivation.

FIG. 6 gives the example where one update motion vector and corresponding residue block can affect up to four equal size blocks in the frame to be updated.

FIG. 7 shows an example when one block can have two update motion vectors, with one from each side.

FIG. 8 shows general bilinear interpolation method.

FIG. 9 shows a block diagram of an MCTF-based encoder, according to the present invention.

FIG. 10 shows a block diagram of an MCTF-based decoder, according to the present invention.

FIG. 11 is a block diagram showing the MCTF decomposition process, according to the present invention.

FIG. 12 is a block diagram showing the MCTF composition process, according to the present invention.

FIG. 13 shows the process for adaptive interpolation for MCFT update step based on weight factor, according to the present invention.

FIG. 14 shows the process for adaptive interpolation for MCFT update step based on block update type.

FIG. 15 shows the process for adaptive interpolation for MCFT update step based on both weight factor and block update type.

FIG. 16 is a block diagram of an electronic device which can be equipped with one or both of the MCTF-based encoding and decoding modules, according to the present invention.

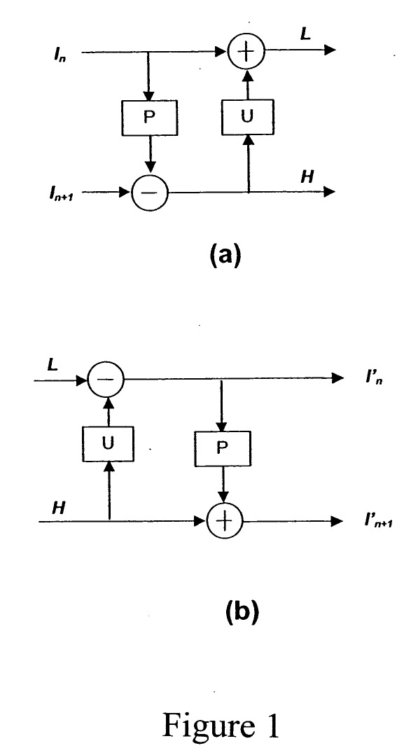

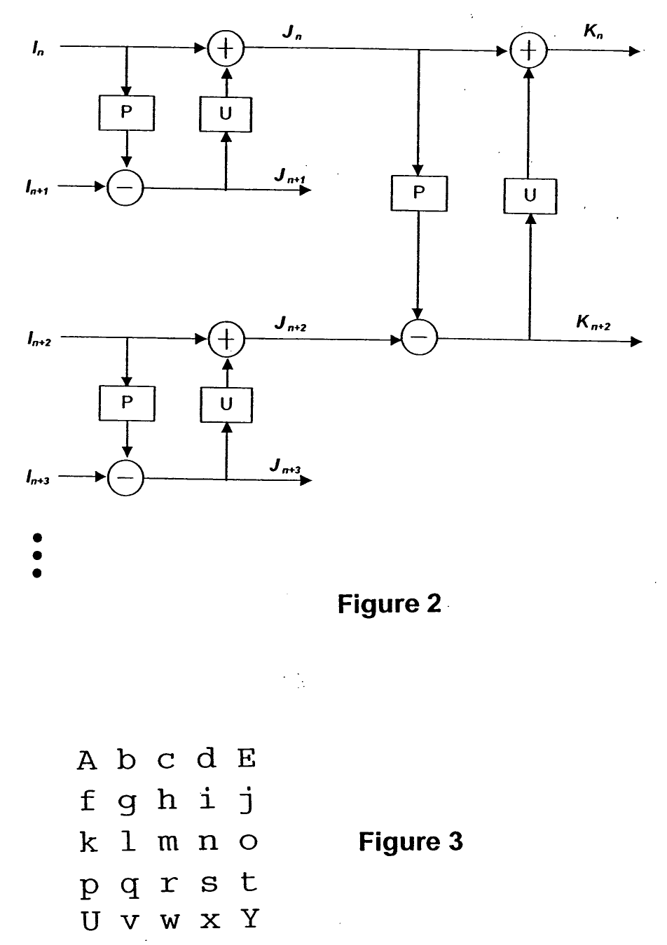

### DETAILED DESCRIPTION OF THE INVENTION

The present invention provides simple but efficient methods for performing the update operation in motion compensated temporal filtering (MCTF) for video coding in order to reduce the complexity in the update operation without significantly affecting the coding performance.

In estimating the energy level of a block that is to be used for update operation, if the block is located at a sub-pixel position, the nearest integer position pixels are used instead of the interpolated pixels of the block.

In the update step, instead of using AVC standard interpolation, a simple adaptive filter is used in interpolating prediction residue block for update operation. The adaptive filter is an adaptive combination of a shorter filter (i.e. a filter with fewer filter taps) and a longer filter (i.e. a filter with more filter taps). For instance, the short filter can be a bilinear filter and the long filter can be a 4-tap FIR (finite impulse response) filter. The switching between the short filter and the long filter is based on either one of the following three criteria:
Based on final weight factor w₁*w₂: If the final weight factor is low, the short filter is used for block interpolation. Otherwise, the long filter is used.
Based on block update type (or number of update motion vectors): After deriving all the updated motion vectors for the frame to be updated, if the current block is a unidirectional update block (i.e. having only one update motion vector), the long filter is used for interpolation of the corresponding residue block. Otherwise, if the current block is a bi-directional update block (i.e. having two update motion vectors from two directions), the short filter is used.
Based on both weight factor and block update type.

Motion vectors that are used for the update step are derived from the motion vectors obtained from the prediction step in MCTF. According to the present invention, a further simplification mechanism for MCTF update step is that only the motion vectors corresponding to larger block size obtained from the prediction step are considered in deriving the motion vectors for update step. For example, if the block size is limited to a minimum of 8×8, and a motion vector in the prediction step is corresponding to a block size smaller than 8×8 (such as 8×4, 4×8 and 4×4), then the motion vector and its associated residue block are not used in the update step. In other words, only motion vectors for 8×8 or larger macroblock partitions are considered in deriving update motion vectors in the update step. In this case, update step can be performed simply on 8×8 block basis instead of 4×4.

Block Energy Estimation Based on Integer Pixels

As explained above, depending on the updated motion vector, interpolation may be needed to obtain sub-pixel values in the update step if the motion vector points to a sub-pixel location in the prediction residue frame. As shown in FIG. 3, A, E, U and Y are integer pixel locations and all other lower-case alphabetical letters indicate sub-pixel locations. As can be seen in FIG. 3, the sub-pixel values are interpolated from integer pixels, directly or indirectly, regardless of what interpolation method is used. As a result, there is a close correlation between the original integer pixel values and neighboring interpolated sub-pixel values. In FIG. 3, it is expected that the values of b, f and g should be very close to the value of A. Based on this fact we also expect that the energy estimation result based on interpolated pixels should also be close to the result that is based on their neighboring original integer pixels.

According to the present invention, in order to obtain weight factor w₂, block energy estimation is performed on the nearest integer pixels and the result is used as an approximation for the real energy level of the interpolated block. With this approach, the complexity of calculations of energy estimation remains the same as in the prior art approach. However, there is an advantage in performing energy estimation based on integer pixels. When the estimated energy level is so high that the block should be excluded from update process (i.e. with a weight factor w₂=0), interpolation for the current block can be totally omitted. This would not be possible if energy estimation is done on interpolated pixels.

Another advantage is that such mechanism makes it possible to use different interpolation methods for the current block based on its block energy level or the correspondingly derived weight factor. This would not be possible if energy estimation is done on interpolated pixels.

Adaptive Interpolation for Update Step Based on Weight Factor

According to the present invention, interpolation for the update step is greatly simplified compared with the method that uses AVC standard interpolation.

In AVC standard, the adoption of the 6-tap filter is a trade-off between complexity and coding performance. It has been found that using a short filter, especially bilinear filter, for interpolation in motion estimation and motion compensation in AVC may bring degradation to the coding performance. The same conclusion still holds for the prediction step of MCTF when it is used in video coding. However, in the update step of MCTF, interpolation is actually done on the prediction residue. It has been found that using a short filter to do interpolation in the update step does not introduce noticeable coding performance degradation. For example, when using a 4-tap filter for interpolation in the update step, there is virtually no coding performance degradation compared with that using AVC standard interpolation.

According to the present invention, a 4-tap filter can be used for interpolation in the MCTF update step. The filter has different filter coefficients for different interpolation positions.
Position 0/4: (0, 16, 0, 0)/16
Position 1/4: (−2, 14, 5, −1)/16
Position 2/4: (−2, 10, 10, −2)/16
Position 3/4: (−1, 5, 14, −2)/16
   Position 0/4 is for integer position pixels. In fact, there is no interpolation needed in this case. Position 1/4, 2/4 and 3/4 are used for interpolation at sub-pixel locations. For sub-pixels with either integer horizontal position or integer vertical position, only one filtering process is sufficient to obtain an interpolated sub-pixel value.

Use of the interpolation filters defined above in the calculation of sub-pixel values will now be described in detail.

In a pixel array having a horizontal row including pixels A₁, A₂, A₃ and A₄, the sub-pixel values to be interpolated in the horizontal row are denoted by x_{1/4}, x_{2/4} and x_{3/4}, respectively. The sub-pixel value x_{1/4} is calculated by applying interpolation filter (1/4), defined above, to pixel values A₁, A₂, A₃ and A₄. Thus, x_{1/4} is given by:
x_{1/4}=((−2A₁)+(14A₂)+(5A₃)+(−1A₄))/16

Sub-pixel x_{2/4} is calculated in an analogous manner by applying interpolation filter (2/4) to pixel values A₁, A₂, A₃ and A₄ and similarly, sub-pixel x_{3/4} is calculated by applying interpolation filter (3/4), as shown below:
x_{2/4}=((−2A₁)+(10A₂)+(10A₃)+(−2A₄))/16
x_{3/4}=((−1A₁)+(5A₂)+(14A₃)+(−2A₄))/16

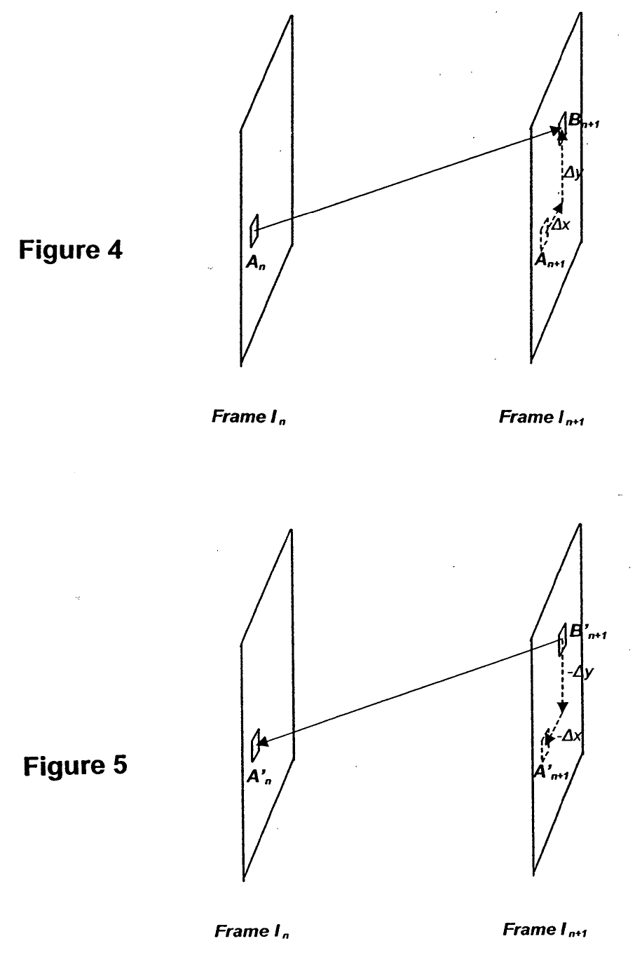

Likewise, in a pixel array having a vertical row including pixels A₁, A₂, A₃ and A₄, the sub-pixel values to be interpolated in the horizontal row are denoted by y_{1/4}, y_{2/4} and y_{3/4} respectively. The sub-pixel values y_{1/4}, y_{2/4} and y_{3/4} are calculated using respectively interpolation filters (1/4), (2/4) and (3/4) applied to the integer location pixel values A₁, A₂, A₃ and A₄ as defined in FIG. 4. More specifically, then:
y_{1/4}=((−2A₁)+(14A₂)+(5A₃)+(−1A₄))/16
y_{2/4}=((−2A₁)+(10A₂)+(10A₃)+(−2A₄))/16
y_{3/4}=((−1A₁)+(5A₂)+(14A₃)+(−2A₄))/16

Interpolation filter (0/4) is included in the set of interpolation filters for completeness and is purely notional as it represents the calculation of a sub-pixel value co-incident with, and having the same value as, a pixel at an integer location. The coefficients of the other 4-tap interpolation filters (1/4), (2/4) and (3/4) are chosen empirically for example, so as to provide the best possible subjective interpolation of the sub-pixel values. For example, it is possible to interpolate rows of sub-pixel values in the horizontal direction first and then interpolate column-by-column in the vertical direction. As such a value for each sub-pixel position between integer location pixels can be obtained.

As shown in FIG. 3, sub-pixel locations b, c, d, f, k, p, j, o, t and v, w, x all belong to this case. For other sub-pixel locations shown in FIG. 3, additional filtering is needed to obtain the interpolation value for that position. Nevertheless, the average operation for interpolating a block using such 4-tap filter is still lower than using AVC standard interpolation.

To further simplify the interpolation process, bilinear filter can also be used in interpolating the prediction residue in the MCTF update step. FIG. 8 shows an arbitrary position q in a video frame. The nearest four integer position pixels to the position q are indicated with solid dots, denoted as p₁, p₂, p₃ and p₄ respectively. With bilinear interpolation, the interpolation value of q is totally depending on the value of p₁, p₂, p₃, p₄ and the relative distance between q and the four integer position pixels. Assume the distance between neighboring integer position pixels is 1. With a location of q as indicated in FIG. 8, the interpolation value of q based on bilinear interpolation is calculated as follows:
q=(1−d)*(1−dy)*p₁+dₓ*(1−dy)*p₂+(1−dx)*dy*p₃+dₓ*dy*p₄

According to the above equation, bilinear interpolation of the pixel positions as shown in FIG. 3 is straightforward. For a sub-pixel with either an integer horizontal position or an integer vertical position, interpolation is only dependent on the closest two integer position pixels. For example, pixel c is interpolated as c=(A+E)/2; pixel f is interpolated as f=(A+A+A+U)/4, etc. For other sub-pixel locations as shown in FIG. 3, interpolation is based on the closest four integer position pixels, i.e. A, E, U and Y. Taking g as an example, the interpolation can be calculated as:
g=(3*3*A+3*1*E+1*3*U+1*1*Y)/16.
Compared with AVC standard interpolation, bilinear interpolation has a much lower complexity.

For the MCTF update step, bilinear interpolation also gives good coding performance, with only slight degradation compared to 4-tap or AVC standard interpolation. In order to keep the low complexity advantage of bilinear interpolation while still maintaining high coding performance, the present invention uses an adaptive interpolation approach based on switching between bilinear and 4-tap filters for the update step interpolation. In the adaptive interpolation approach, the switching between bilinear interpolation and 4-tap interpolation is based on a weight factor of the current block to be interpolated.

As explained above, a weight factor is used to control update strength. The weight factor is an indicator of how reliable the update motion vector is and how unlikely the update operation can cause coding artifacts. If the weight factor is large, it indicates that it is relatively safe to do the update operation on the associated block. When choosing an interpolation filter, we would like to use a relatively long filter, e.g. 4-tap filter, for interpolation for blocks with a larger weight factor because these blocks are more important in maintaining the coding performance. For blocks with a lower weight factor, a short filter, e.g. bilinear filter, is sufficient and preferable.

Before interpolation of corresponding prediction residue for a block in the update step, the final weight factor for the block is first calculated. Assume the final weight factor is w and it is a normalized value so that w is in the range of [0, 1]. Tₕ is a pre-determined threshold in the range of [0, 1]. The adaptive interpolation mechanism is that if w>Tₕ, the long filter, e.g. 4-tap filter, is used in interpolation for the current block. Otherwise, the short filter, e.g. bilinear filter, is used. The threshold Tₕ can be determined through a testing procedure. The testing result provides a trade-off between complexity and coding performance. When Tₕ is low, more blocks are interpolated with the long filter. When Tₕ, is high, the short filter is more often used. Two extreme cases are: when Tₕ=0, the long filter is always selected; when Tₕ=1, the short filter is always selected. Generally Tₕ=0.5 can be a good trade-off value. In this case it provides no obvious coding performance degradation.

Adaptive Interpolation for Update Step Based on Block Update Type (or Number of Update Motion Vectors)

In another embodiment of the present invention, adaptive interpolation can be controlled based on block update type, or in other words, by the number of update motion vectors for the current block. As explained above, it is possible for a block to have two update motion vectors. One such example is shown in FIG. 7 when bi-directional predicted frame (or B-frame) is used in video coding. In this example, the compensated residue from each side is averaged and the result is used for update for the block.

Based on the number of update motion vectors, a block in the frame to be updated can be classified into three categories. Different interpolation methods are applied accordingly to interpolate the corresponding prediction residue for that block:
If a block has no update motion vector, no update (and therefore no interpolation) is needed for that block.
If a block has just one update motion vector, we call it a unidirectional update block. In this case, a relatively long filter is used for interpolation of the corresponding prediction residue for the block.
If a block has two update motion vectors, we call it a bi-directional update block. In this case, a short filter is used for interpolation of the block.

As mentioned above, when a block has two update motion vectors, the compensated residue from each side is averaged and the result is used for update for that block. Since the interpolation result is later averaged, there is no need to use a long filter to do the interpolation at the beginning in this case.

Adaptive Interpolation for Update Step Based on Both Block Update Type and Weight Factor

In a further embodiment of the present invention, adaptive interpolation can be controlled based on both the block update type and the weight factor in the update step. The control mechanism used in this method is a combination of the above two methods.

In this method, the block update type is first checked and the final weight factor is also calculated for a block before interpolation of the corresponding prediction residue block for the block. Two thresholds values, Tₕ₁ and Tₕ₂, are predetermined for unidirectional update block and bi-directional update block respectively. To determine the interpolation method for a block, first the block update type is checked:
If the block is a unidirectional update block, the weight factor of the block is checked against the threshold value Tₕ₁. If the weight factor is bigger than Tₕ₁, the relatively long filter is used in interpolation; otherwise, the short filter is used.
If the block is a bi-directional update block, the weight factor of the block is checked against the threshold value Tₕ₂. If the weight factor is bigger than Tₕ₂, the long filter is used in interpolation; otherwise, the short filter is used.
   Update Motion Vector Derivation Based on 8×8 Block

In the present invention, we also use a method in deriving update motion vectors simply based on coding blocks with larger block size, e.g. a minimum of 8×8.

Taking a minimum block size of 8×8 as an example. According to this method, motion vectors corresponding to a block size smaller than 8×8 (such as 8×4, 4×8 and 4×4 as specified in AVC standard) are excluded from, and therefore not used for, the update step. The main procedure for the update step as described above remains the same, except that in this method everything is performed on an 8×8 block basis.

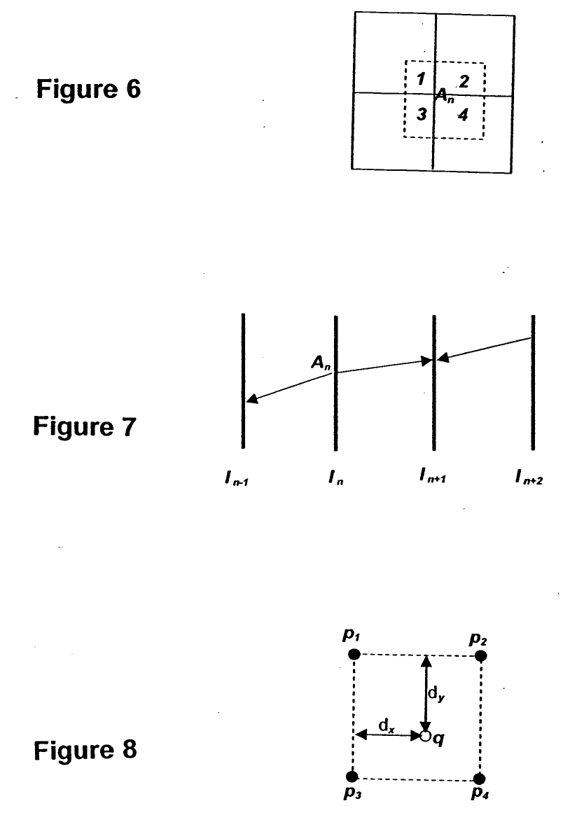

For example, each block in the frame to be updated has a size of 8×8. All the motion vectors with a block size of at least 8×8 in the prediction step are scanned in the derivation of update motion vectors. With this method, the situation as shown in FIG. 6 still holds except that each rectangular area represents an 8×8 block. Weighing factors w₁ and w₂ can be obtained in a similar manner based on 8×8 blocks. Finally interpolation of prediction residue in update step is also done on 8×8 blocks.

Generally only a small percentage of motion vectors are corresponding to block size smaller than 8×8 and meanwhile these motion vectors may not be so reliable to be used for update process. Excluding these motion vectors from update process does not significantly affect coding performance. For that reason, update motion vectors can be derived simply based on 8×8 block and the entire process can be greatly simplified

Advantages

In terms of interpolation, both the 4-tap filter and the bilinear filter are simpler than the AVC standard interpolation. Especially the use of bilinear filter can dramatically reduce the interpolation complexity for update process. Furthermore, the present invention uses a long filter, e.g. the 4-tap filter, and a short filter, e.g. the bilinear filter, adaptively so that performance degradation is minimized while the filtering process is so much simplified.

In terms of update motion vector derivation, the present invention provides a method in which update motion vectors are derived based on larger block size, e.g. 8×8 blocks. As such, the process for update motion vector derivation is greatly simplified.

In terms of block energy estimation, it is found that estimation based on integer pixels gives a very close result to that based on sub-pixels (or interpolated pixels). Meanwhile, there is an obvious advantage doing it based on integer pixels. For instance, when the estimated energy level is so high that the block should be excluded from update process (i.e. with a weight factor w₂=0), interpolation for the current block is no longer needed. Another advantage is that this makes it possible to select different interpolation method for the current block based on its block energy level or the correspondingly derived weight factor.

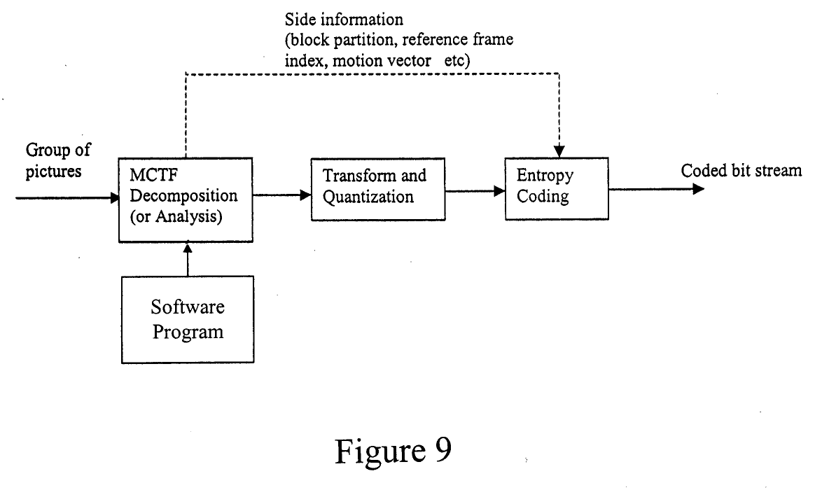

FIG. 9 shows a block diagram of an MCTF-based encoder, according to the present invention. As explained earlier, the MCTF Decomposition module includes both prediction step and update step. This module generates prediction residue and some side information including block partition, reference frame index, motion vector, etc, Prediction residue is transformed, quantized and then sent to Entropy Coding module. Side information is also sent to Entropy Coding module. Entropy Coding module encodes all the information into compressed bitstream.

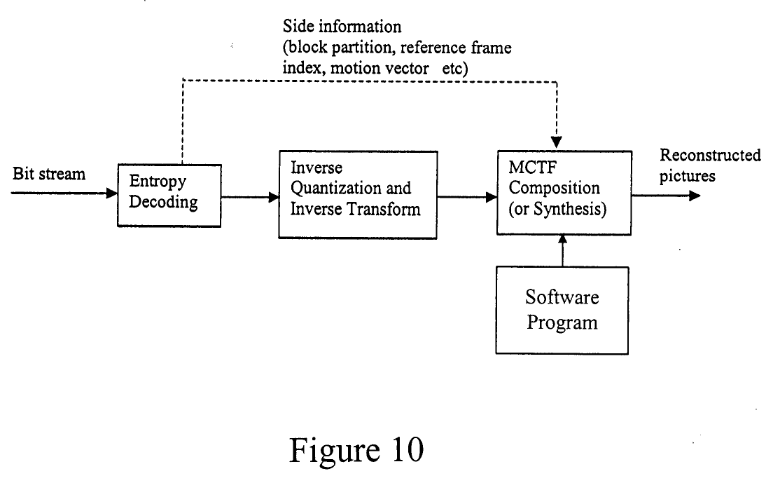

FIG. 10 shows a block diagram of an MCTF-based decoder, according to the present invention. Through Entropy Decoding module, bitstream is decompressed, which provides both prediction residue and side information including block partition, reference frame index and motion vector, etc. Prediction residue is then de-quantized, inverse-transformed and then sent to MCTF Composition module. Through MCTF composition process, video pictures are reconstructed.

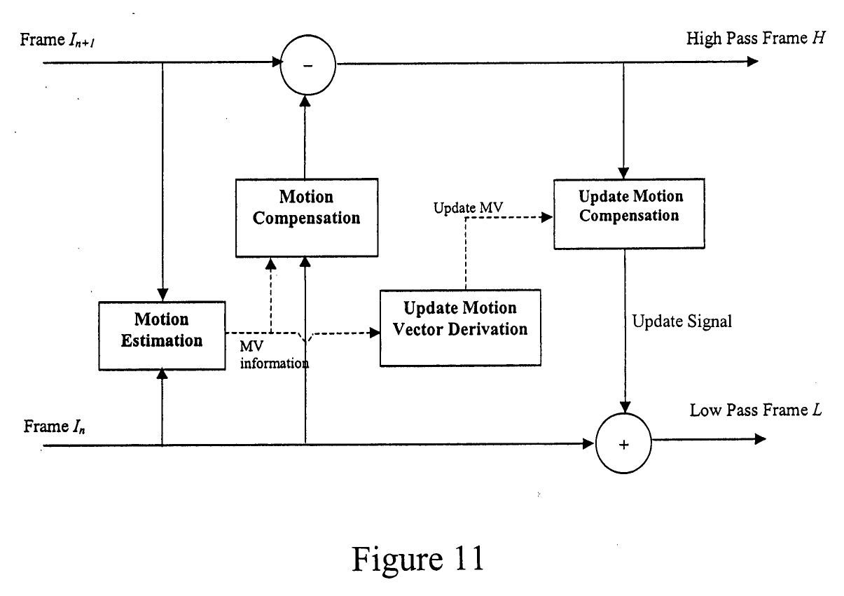

FIG. 11 is a block diagram showing the MCTF decomposition process, according to the present invention. As described earlier in this invention, the process includes prediction step and update step. In the figure, Motion Estimation module and Motion Compensation module are used in prediction step. Other modules are used in update step. Motion vectors from Motion Estimation module are also used in update step to derive motion vectors used for update step, which is done in Update Motion Vector Derivation module. Motion compensation process is performed in both the prediction step and the update step.

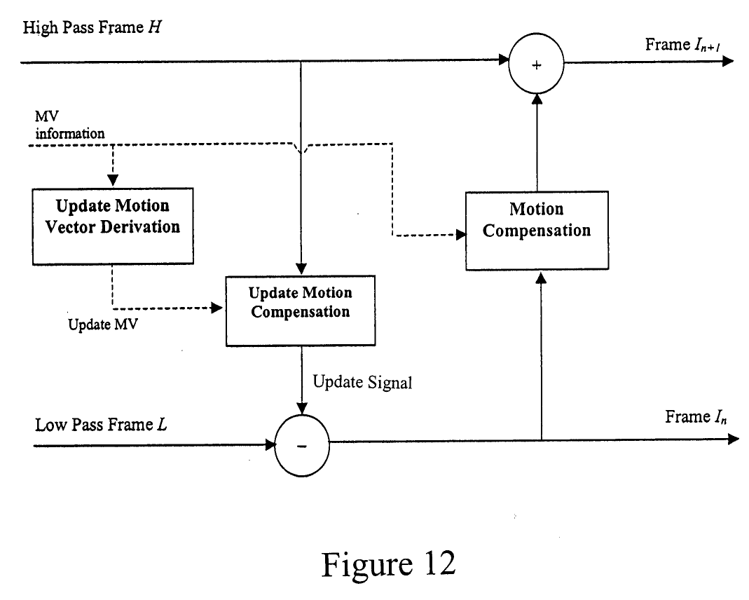

FIG. 12 is a block diagram showing the MCTF composition process, according to the present invention. Based on received and decoded motion vector information, update motion vectors are derived in the Update Motion Vector Derivation module. Then the same motion compensation processes as that in MCTF decomposition process are performed. Compared with FIG. 11, it can be seen the MCTF composition is the reverse process of MCTF decomposition.

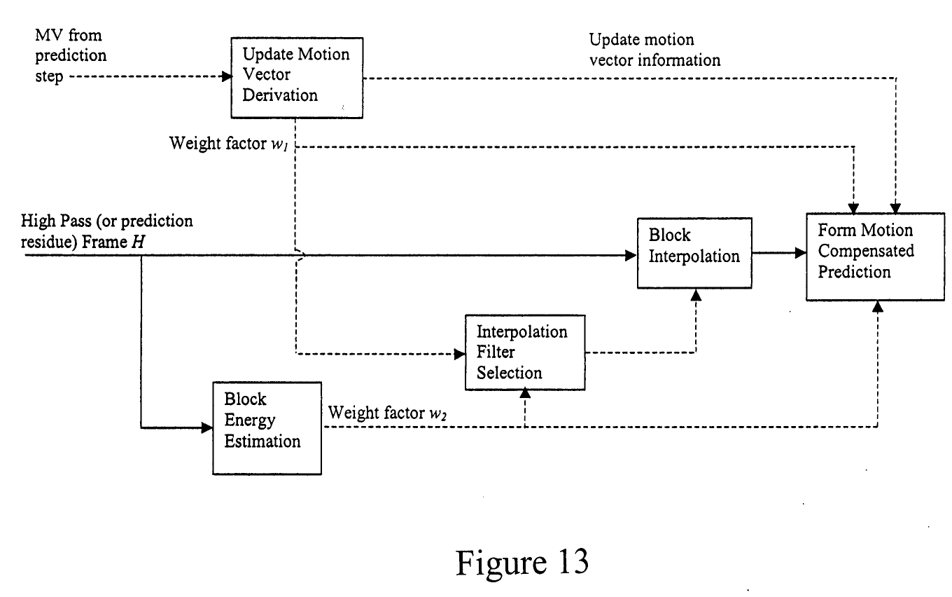

FIG. 13 shows the process for adaptive interpolation for MCFT update step based on weight factor, according to the present invention. In this figure, two weight factors are derived, with one from Update Motion Vector Derivation module and the other one from Block Energy Estimation module. Interpolation Filter Selection module makes filter selection decision based on the two weight factors. Block Interpolation module performs interpolation using selected filter on prediction residue block. The interpolated result is then used for motion compensation in update step.

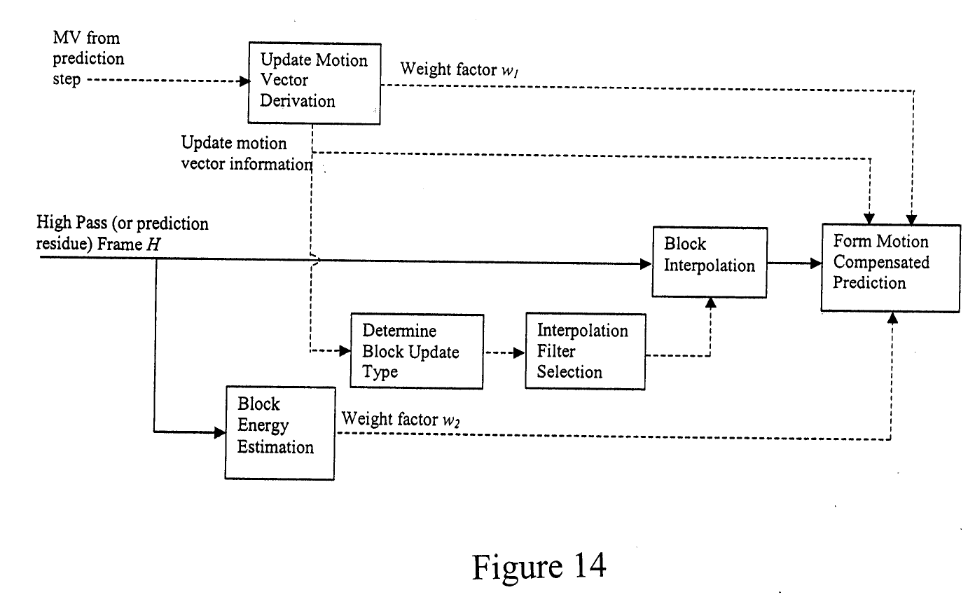

FIG. 14 shows the process for adaptive interpolation for MCFT update step based on block update type. In this figure, Determine Block Update Type block tells if a block is going to be updated from one direction or from two directions based on the number of update motion vectors available for the block. Such information is then used in Interpolation Filter Selection module in making filter selection decision. Interpolation is performed in Block Interpolation module and the result is used for motion compensation.

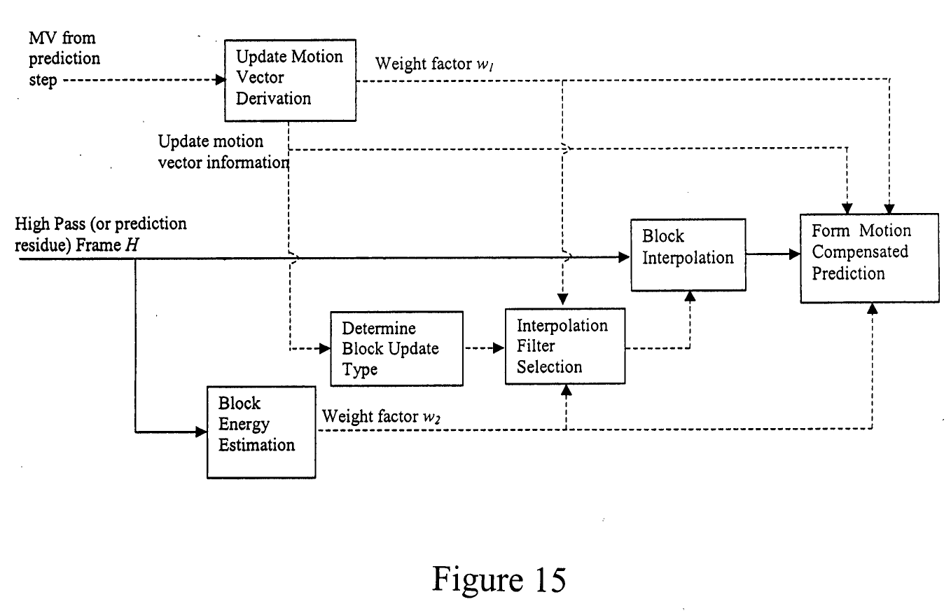

FIG. 15 shows the process for adaptive interpolation for MCFT update step based on both weight factor and block update type. In this figure, information provided to Interpolation Filter Selection module includes both the weight factor from Block Energy Estimation module and the number of update motion vectors from Determine Block Update Type module. Based on all these information, interpolation filter is selected. Interpolation is performed in Block Interpolation module and the result is used for motion compensation.

It should be noted that at least some of the MCTF composition and decomposition processes, according to the present invention, are carried out by software programs as indicated on FIGS. 9 and 10.

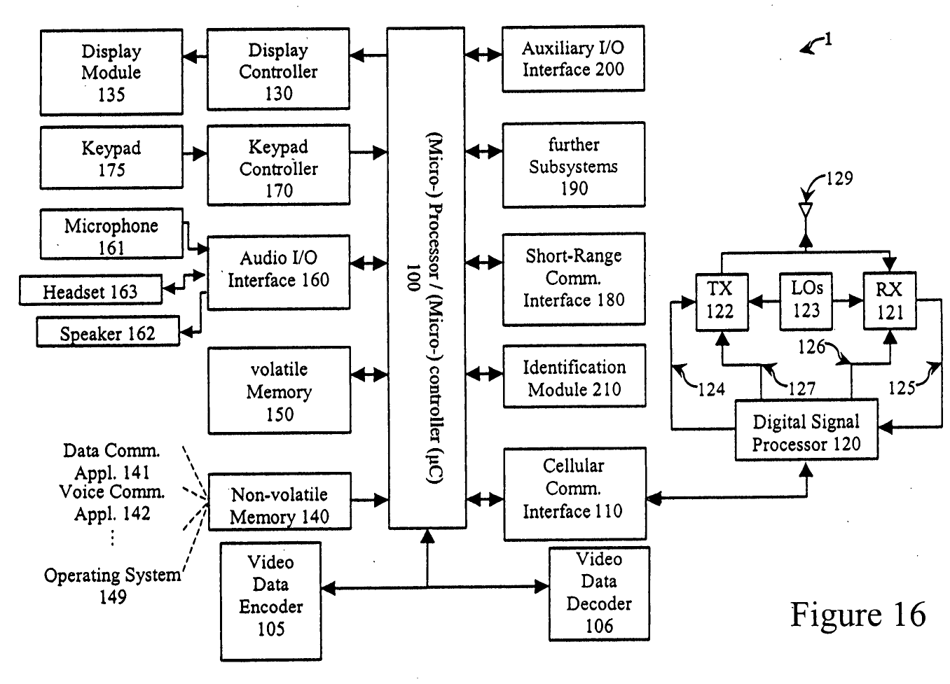

FIG. 16 shows an electronic device that equips at least one of the MCTF encoding module and the MCTF decoding module as shown in FIGS. 9 and 10. FIG. 16 depicts a typical mobile device according to an embodiment of the present invention. The mobile device 1 shown in FIG. 16 is capable of cellular data and voice communications. It should be noted that the present invention is not limited to this specific embodiment, which represents one of a multiplicity of different embodiments. The mobile device 1 includes a (main) microprocessor or microcontroller 100 as well as components associated with the microprocessor controlling the operation of the mobile device. These components include a display controller 130 connecting to a display module 135, a non-volatile memory 140, a volatile memory 150 such as a random access memory (RAM), an audio input/output (I/O) interface 160 connecting to a microphone 161, a speaker 162 and/or a headset 163, a keypad controller 170 connected to a keypad 175 or keyboard, any auxiliary input/output (I/O) interface 200, and a short-range communications interface 180. Such a device also typically includes other device subsystems shown generally at 190.

The mobile device 1 may communicate over a voice network and/or may likewise communicate over a data network, such as any public land mobile networks (PLMNs) in form of e.g. digital cellular networks, especially GSM (global system for mobile communication) or UMTS (universal mobile telecommunications system). Typically the voice and/or data communication is operated via an air interface, i.e. a cellular communication interface subsystem in cooperation with further components (see above) to a base station (BS) or node B (not shown) being part of a radio access network (RAN) of the infrastructure of the cellular network.

The cellular communication interface subsystem as depicted illustratively in FIG. 16 comprises the cellular interface 110, a digital signal processor (DSP) 120, a receiver (RX) 121, a transmitter (TX) 122, and one or more local oscillators (LOs) 123 and enables the communication with one or more public land mobile networks (PLMNs). The digital signal processor (DSP) 120 sends communication signals 124 to the transmitter (TX) 122 and receives communication signals 125 from the receiver (RX) 121. In addition to processing communication signals, the digital signal processor 120 also provides for the receiver control signals 126 and transmitter control signal 127. For example, besides the modulation and demodulation of the signals to be transmitted and signals received, respectively, the gain levels applied to communication signals in the receiver (RX) 121 and transmitter (TX) 122 may be adaptively controlled through automatic gain control algorithms implemented in the digital signal processor (DSP) 120. Other transceiver control algorithms could also be implemented in the digital signal processor (DSP) 120 in order to provide more sophisticated control of the transceiver 121/122.

In case the mobile device 1 communications through the PLMN occur at a single frequency or a closely-spaced set of frequencies, then a single local oscillator (LO) 123 may be used in conjunction with the transmitter (TX) 122 and receiver (RX) 121. Alternatively, if different frequencies are utilized for voice/data communications or transmission versus reception, then a plurality of local oscillators can be used to generate a plurality of corresponding frequencies.

Although the mobile device 1 depicted in FIG. 16 is used with the antenna 129 as or with a diversity antenna system (not shown), the mobile device 1 could be used with a single antenna structure for signal reception as well as transmission. Information, which includes both voice and data information, is communicated to and from the cellular interface 110 via a data link between the digital signal processor (DSP) 120. The detailed design of the cellular interface 110, such as frequency band, component selection, power level, etc., will be dependent upon the wireless network in which the mobile device 1 is intended to operate.

After any required network registration or activation procedures, which may involve the subscriber identification module (SIM) 210 required for registration in cellular networks, have been completed, the mobile device 1 may then send and receive communication signals, including both voice and data signals, over the wireless network. Signals received by the antenna 129 from the wireless network are routed to the receiver 121, which provides for such operations as signal amplification, frequency down conversion, filtering, channel selection, and analog to digital conversion. Analog to digital conversion of a received signal allows more complex communication functions, such as digital demodulation and decoding, to be performed using the digital signal processor (DSP) 120. In a similar manner, signals to be transmitted to the network are processed, including modulation and encoding, for example, by the digital signal processor (DSP) 120 and are then provided to the transmitter 122 for digital to analog conversion, frequency up conversion, filtering, amplification, and transmission to the wireless network via the antenna 129.

The microprocessor/microcontroller (μC) 110, which may also be designated as a device platform microprocessor, manages the functions of the mobile device 1. Operating system software 149 used by the processor 110 is preferably stored in a persistent store such as the non-volatile memory 140, which may be implemented, for example, as a Flash memory, battery backed-up RAM, any other non-volatile storage technology, or any combination thereof. In addition to the operating system 149, which controls low-level functions as well as (graphical) basic user interface functions of the mobile device 10, the non-volatile memory 140 includes a plurality of high-level software application programs or modules, such as a voice communication software application 142, a data communication software application 141, an organizer module (not shown), or any other type of software module (not shown). These modules are executed by the processor 100 and provide a high-level interface between a user of the mobile device 1 and the mobile device 1. This interface typically includes a graphical component provided through the display 135 controlled by a display controller 130 and input/output components provided through a keypad 175 connected via a keypad controller 170 to the processor 100, an auxiliary input/output (I/O) interface 200, and/or a short-range (SR) communication interface 180. The auxiliary I/O interface 200 comprises especially USB (universal serial bus) interface, serial interface, MMC (multimedia card) interface and related interface technologies/standards, and any other standardized or proprietary data communication bus technology, whereas the short-range communication interface radio frequency (RF) low-power interface includes especially WLAN (wireless local area network) and Bluetooth communication technology or an IRDA (infrared data access) interface. The RF low-power interface technology referred to herein should especially be understood to include any IEEE 801.xx standard technology, which description is obtainable from the Institute of Electrical and Electronics Engineers. Moreover, the auxiliary I/O interface 200 as well as the short-range communication interface 180 may each represent one or more interfaces supporting one or more input/output interface technologies and communication interface technologies, respectively. The operating system, specific device software applications or modules, or parts thereof, may be temporarily loaded into a volatile store 150 such as a random access memory (typically implemented on the basis of DRAM (direct random access memory) technology for faster operation). Moreover, received communication signals may also be temporarily stored to volatile memory 150, before permanently writing them to a file system located in the non-volatile memory 140 or any mass storage preferably detachably connected via the auxiliary I/O interface for storing data. It should be understood that the components described above represent typical components of a traditional mobile device 1 embodied herein in the form of a cellular phone. The present invention is not limited to these specific components and their implementation depicted merely for illustration and for the sake of completeness.

An exemplary software application module of the mobile device 1 is a personal information manager application providing PDA functionality including typically a contact manager, calendar, a task manager, and the like. Such a personal information manager is executed by the processor 100, may have access to the components of the mobile device 1, and may interact with other software application modules. For instance, interaction with the voice communication software application allows for managing phone calls, voice mails, etc., and interaction with the data communication software application enables for managing SMS (soft message service), MMS (multimedia service), e-mail communications and other data transmissions. The non-volatile memory 140 preferably provides a file system to facilitate permanent storage of data items on the device including particularly calendar entries, contacts etc. The ability for data communication with networks, e.g. via the cellular interface, the short-range communication interface, or the auxiliary I/O interface enables upload, download, and synchronization via such networks.

The application modules 141 to 149 represent device functions or software applications that are configured to be executed by the processor 100. In most known mobile devices, a single processor manages and controls the overall operation of the mobile device as well as all device functions and software applications. Such a concept is applicable for today's mobile devices. The implementation of enhanced multimedia functionalities includes, for example, reproducing of video streaming applications, manipulating of digital images, and capturing of video sequences by integrated or detachably connected digital camera functionality. The implementation may also include gaming applications with sophisticated graphics and the necessary computational power. One way to deal with the requirement for computational power, which has been pursued in the past, solves the problem for increasing computational power by implementing powerful and universal processor cores. Another approach for providing computational power is to implement two or more independent processor cores, which is a well known methodology in the art. The advantages of several independent processor cores can be immediately appreciated by those skilled in the art. Whereas a universal processor is designed for carrying out a multiplicity of different tasks without specialization to a pre-selection of distinct tasks, a multi-processor arrangement may include one or more universal processors and one or more specialized processors adapted for processing a predefined set of tasks. Nevertheless, the implementation of several processors within one device, especially a mobile device such as mobile device 1, requires traditionally a complete and sophisticated re-design of the components.

In the following, the present invention will provide a concept which allows simple integration of additional processor cores into an existing processing device implementation enabling the omission of expensive complete and sophisticated redesign. The inventive concept will be described with reference to system-on-a-chip (SoC) design. System-on-a-chip (SoC) is a concept of integrating at least numerous (or all) components of a processing device into a single high-integrated chip. Such a system-on-a-chip can contain digital, analog, mixed-signal, and often radio-frequency functions—all on one chip. A typical processing device comprises a number of integrated circuits that perform different tasks. These integrated circuits may include especially microprocessor, memory, universal asynchronous receiver-transmitters (UARTs), serial/parallel ports, direct memory access (DMA) controllers, and the like. A universal asynchronous receiver-transmitter (UART) translates between parallel bits of data and serial bits. The recent improvements in semiconductor technology cause very-large-scale integration (VLSI) integrated circuits to enable a significant growth in complexity, making it possible to integrate numerous components of a system in a single chip. With reference to FIG. 16, one or more components thereof, e.g. the controllers 130 and 170, the memory components 150 and 140, and one or more of the interfaces 200, 180 and 110, can be integrated together with the processor 100 in a signal chip which forms finally a system-on-a-chip (Soc).

Additionally, the device 1 is equipped with a module for scalable encoding 105 and scalable decoding 106 of video data according to the inventive operation of the present invention. By means of the CPU 100 said modules 105, 106 may individually be used. However, the device 1 is adapted to perform video data encoding or decoding respectively. Said video data may be received by means of the communication modules of the device or it also may be stored within any imaginable storage means within the device 1. Video data can be conveyed in a bitstream between the device 1 and another electronic device in a communications network.

Although the invention has been described with respect to one or more embodiments thereof, it will be understood by those skilled in the art that the foregoing and various other changes, omissions and deviations in the form and detail thereof may be made without departing from the scope of this invention.

What is claimed is:

1. A method for use in update operation of motion compensated temporal filtering of video frames, said method comprising:
adaptively selecting an interpolation filter from a set of filters comprising at least a shorter filter and a longer filter; and
obtaining update signal through interpolation of prediction residue based on said interpolation filter.

2. The method of claim 1, wherein the interpolation filter is selected on a block basis from the set of filters based at least on a weight factor calculated for a block in a video frame comprising multiple blocks, said method further comprising:
estimating an energy level of a prediction residue block corresponding to the block; and
determining the weight factor for the block based at least on the estimated energy.

3. The method of claim 1, wherein the interpolation filter is selected on a block basis from the set of filters based at least on number of update motion vectors available for a block in a video frame comprising multiple blocks.

4. The method of claim 1, wherein the interpolation filter is selected on a block basis from the set of filters based at least on both a weight factor and number of update motion vectors available for a block in a video frame comprising multiple blocks.

5. The method of claim 2, wherein said estimating is based on prediction residues at nearest integer pixel locations relative to the prediction residue block position in case the prediction residue block is located at partial pixel location.

6. The method of claim 1, further comprising:
deriving, for each block in a video frame, update motion vectors based on motion vectors used for blocks of at least a certain size or larger in prediction process of motion compensated temporal filtering of video frames.

7. The method of claim 2, further comprising:
comparing the weight factor of the block to a predetermined threshold;
selecting the longer filter as the interpolation filter if the weight factor is larger than the predetermined threshold; and
selecting the short filter as the interpolation filter if the weight factor is smaller than or equal to the predetermined threshold.

8. The method of claim 3, wherein if said number is one, select the longer filter as the interpolation filter for the block in said selecting, and if said number is greater than one, select the shorter filter as the interpolation filter.

9. The method of claim 4, further comprising:
if said number is one,
comparing the weight factor of the block to a first predetermined threshold, such that if the weight factor is larger than the first predetermined value, select the longer filter as the interpolation filter, otherwise select the shorter filter as the interpolation filter; and
if said number is greater than one,
comparing the weight factor of the block to a second predetermined threshold, such that if the weight factor is larger than the second predetermined value, select the longer filter as the interpolation filter, otherwise select the shorter filter as the interpolation filter

10. The method of claim 1, wherein said shorter filter comprises a bi-linear filter.

11. The method of claim 1, wherein said longer filter is longer than a 2-tap filter.

12. An electronic module for use in an update operation of motion compensated temporal filtering of video frame, comprising:
an interpolation module for adaptively selecting an interpolation filter from a set of filters comprising at least a shorter filter and a longer filter for obtaining an update signal through interpolation prediction residue based on said interpolation filter.

13. The electronic module of claim 12, wherein the interpolation filter is selected on a block basis from the set of filters based at least on a weight factor calculated for a block in a video frame comprising multiple blocks, said module further comprising:
an estimation block for estimating an energy level of a prediction residue block corresponding to the block so as to determine the weight factor for the block based at least on the estimated energy.

14. The electronic module of claim 13, wherein said estimating is based on prediction residues at nearest integer pixel locations relative to the prediction residue block position in case the prediction residue block is located at partial pixel location.

15. The electronic module of claim 12, further comprising:
a derivation module for deriving, for each block in a video frame, update motion vectors based on motion vectors used for blocks of at least a certain size or larger in prediction step of motion compensated temporal filtering of video frames.

16. The electronic module of claim 13, wherein the longer filter is selected for use as the interpolation filter of the block if the weight factor of the block is larger than a predetermined threshold, otherwise the shorter filter is selected.

17. The electronic module of claim 12, wherein the interpolation filter is selected on a block basis from the set of filters based at least on a number of update motion vectors for a block in a video frame comprising multiple blocks, and wherein the longer filter is selected for use as the interpolation filter if said number is one, and the shorter filter is selected if said number is greater than one.

18. The electronic module of claim 13, wherein the interpolation filter is selected on a block basis from the set of filters also based at least on number of update motion vectors for a block in a video frame comprising multiple blocks, such that
if said number is one,
the longer filter is selected for use as the interpolation filter if the weight factor is larger than a first predetermined value, otherwise use the shorter filter as the interpolation filter; and
if said number is greater than one,
the longer filter is selected for use as the interpolation filter if the weight factor is larger than a second predetermined value, otherwise use the shorter filter as the interpolation filter.

19. A software application product, comprising a storage medium having a software application for use in update operation of motion compensated temporal filtering of video frames, said software application comprising:
program code for adaptively selecting an interpolation filter from a set of filters comprising at least a shorter filter and a longer filter; and
program code for obtaining update signal through interpolation of prediction residue based on said interpolation filter.

20. The software application product of claim 19, wherein the interpolation filter is selected on a block basis from the set of filters based at least on a weight factor calculated for a block in a video frame comprising multiple blocks, said software application further comprising:
program code for estimating an energy level of a prediction residue block corresponding to the block; and
program code for determining the weight factor for the block based at least on the estimated energy.

21. The software application product of claim 19, wherein the interpolation filter is selected on a block basis from the set of filters based at least on number of update motion vectors available for a block in a video frame comprising multiple blocks.

22. The software application product of claim 19, wherein the interpolation filter is selected on a block basis from the set of filters based at least on both a weight factor and number of update motion vectors available for a block in a video frame comprising multiple blocks.

23. The software application product of claim 20, wherein said estimating is based on prediction residues at nearest integer pixel locations relative to the prediction residue block position in case the prediction residue block is located at partial pixel location.

24. The software application product of claim 19, wherein said software application further comprises:
program code for deriving, for each block in a video frame, update motion vectors based on motion vectors used for blocks of at least a certain size or larger in prediction process of motion compensated temporal filtering of video frames.

25. The software application product of claim 20, wherein said software application further comprises:
program code for comparing the weight factor of the block to a predetermined threshold;
program code for selecting the longer filter as the interpolation filter if the weight factor is larger than the predetermined threshold; and selecting the short filter as the interpolation filter if the weight factor is smaller than or equal to the predetermined threshold.

26. An electronic device, comprising:
a communication module for establishing a communication link with another electronic device for conveying a bitstream having video data, the video data comprising video frames; and
a video data processing module, responsive to the video data, for carrying out motion compensated scalable video coding, including an update operation of motion compensated temporal filtering of the video frames, said processing module comprising an interpolation module for adaptively selecting an interpolation filter from a set of filters comprising at least a shorter filter and a longer filter for obtaining an update signal through interpolation prediction residue based on said interpolation filter.

27. The electronic device of claim 26, wherein the interpolation filter is selected on a block basis from the set of filters based at least on a weight factor calculated for a block in a video frame comprising multiple blocks, said processing module further comprising:
an estimation block for estimating an energy level of a prediction residue block correspond to the block so as to determine the weight factor for the block based at least on the estimated energy.

28. The electronic device of claim 27, wherein said estimating is based on prediction residues at nearest integer pixel locations relative to the prediction residue block position in case the prediction residue block is located at partial pixel location.

29. The electronic device of claim 26, wherein the processing module further comprises
a derivation module for deriving, for each block in a video frame, update motion vectors based on motion vectors used for blocks of at least a certain size or larger in prediction step of motion compensated temporal filtering of video frames.

30. The electronic device of claim 27, wherein the longer filter is selected for use as the interpolation filter of the block if the weight factor of the block is larger than a predetermined threshold, otherwise the shorter filter is selected.

31. The electronic device of claim 26, wherein the interpolation filter is selected on a block basis from the set of filters based at least on a number of update motion vectors for a block in a video frame comprising multiple blocks, and wherein the longer filter is selected for use as the interpolation filter if said number is one, and the shorter filter is selected if said number is greater than one.

32. The electronic device of claim 26, wherein the processing module comprises a video decoder and wherein the update operation is part of a motion compensated scalable video decoding process.

33. The electronic device of claim 26, wherein the processing module comprises a video encoder and wherein the update operation is part of a motion compensated scalable video encoding process.

34. The electronic device of claim 26, comprising a mobile terminal.
